(19) United States
(12) Patent Application Publication
(10) Pub. No.: US 2026/0269450 A1
(43) Pub. Date: Sep. 10, 2026

(54) QUICK-DETACHABLE ANTENNA SIGNAL TRANSMISSION MODULE AND METHOD FOR MANUFACTURING THE SAME

(71) Applicant: INPAQ TECHNOLOGY CO., LTD., MIAOLI COUNTY (TW)

(72) Inventors: CHIH-CHEN LIN, New Taipei City (TW); XIAN-XIU HONG, Taoyuan City (TW); JUNG-MOU CHENG, New Taipei City (TW)

(21) Appl. No.: 19/171,337

(22) Filed: Apr. 6, 2025

(30) Foreign Application Priority Data
Mar. 7, 2025 (TW) 114108497

(51) Int. Cl. H01Q 1/08; H01Q 1/14

(52) U.S. Cl. CPC H01Q 1/088; H01Q 1/14

(57) ABSTRACT

A quick-detachable antenna signal transmission module and a method for manufacturing the same. The quick-detachable antenna signal transmission module includes a first antenna signal transmission structure and a second antenna signal transmission structure. The first antenna signal transmission structure includes a first quick-release structure matching casing and a first quick-release signal transmission assembly partially enclosed by the first quick-release structure matching casing. The second antenna signal transmission structure includes a second quick-release structure matching casing and a second quick-release signal transmission assembly partially enclosed by the second quick-release structure matching casing. When the first quick-release structure matching casing is configured to be fixed on an electronic product housing, the second quick-release structure matching casing is configured to be detachably connected to the first quick-release structure matching casing, and the second quick-release signal transmission assembly is configured to be detachably connected to the first quick-release signal transmission assembly.

### CROSS-REFERENCE TO RELATED PATENT APPLICATION

This application claims the benefit of priority to Taiwan Patent Application No. 114108497, filed on Mar. 7, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a transmission module and a method for manufacturing the same, and more particularly to a quick-detachable antenna signal transmission module and a method for manufacturing the same.

### BACKGROUND OF THE DISCLOSURE

In the related art, an antenna module needs to be assembled on an electronic product by using additional tools or rotating it several times, so there is still room for improvement.

### SUMMARY OF THE DISCLOSURE

In response to the above-referenced technical inadequacy, the present disclosure provides a quick-detachable antenna signal transmission module for transmitting antenna signals and a method for manufacturing the same.

In order to solve the above-mentioned problems, one of the technical aspects adopted by the present disclosure is to provide a quick-detachable antenna signal transmission module, which includes a first antenna signal transmission structure and a second antenna signal transmission structure. The first antenna signal transmission structure includes a first quick-release structure matching casing and a first quick-release signal transmission assembly partially enclosed by the first quick-release structure matching casing. The second antenna signal transmission structure includes a second quick-release structure matching casing and a second quick-release signal transmission assembly partially enclosed by the second quick-release structure matching casing. When the first quick-release structure matching casing of the first antenna signal transmission structure is configured to be fixed on an electronic product housing, the second quick-release structure matching casing of the second antenna signal transmission structure is configured to be detachably connected to the first quick-release structure matching casing of the first antenna signal transmission structure, and the second quick-release signal transmission assembly of the second antenna signal transmission structure is configured to be detachably connected to the first quick-release signal transmission assembly of the first antenna signal transmission structure.

In order to solve the above-mentioned problems, another one of the technical aspects adopted by the present disclosure is to provide a quick-detachable antenna signal transmission module, which includes a first antenna signal transmission structure and a second antenna signal transmission structure. The first antenna signal transmission structure includes a first quick-release structure matching casing and a first quick-release signal transmission assembly partially enclosed by the first quick-release structure matching casing. The second antenna signal transmission structure includes a second quick-release structure matching casing and a second quick-release signal transmission assembly partially enclosed by the second quick-release structure matching casing. The second quick-release structure matching casing of the second antenna signal transmission structure is configured to be detachably connected to the first quick-release structure matching casing of the first antenna signal transmission structure. The second quick-release signal transmission assembly of the second antenna signal transmission structure is configured to be detachably connected to the first quick-release signal transmission assembly of the first antenna signal transmission structure.

In order to solve the above-mentioned problems, yet another one of the technical aspects adopted by the present disclosure is to provide a method for manufacturing a quick-detachable antenna signal transmission module, which includes: making a first antenna signal transmission structure, wherein the first antenna signal transmission structure includes a first quick-release structure matching casing and a first quick-release signal transmission assembly partially enclosed by the first quick-release structure matching casing; making a second antenna signal transmission structure, wherein the second antenna signal transmission structure includes a second quick-release structure matching casing and a second quick-release signal transmission assembly partially enclosed by the second quick-release structure matching casing; and detachably matching the first antenna signal transmission structure and the second antenna signal transmission structure with each other. When the first quick-release structure matching casing of the first antenna signal transmission structure is configured to be fixed on an electronic product housing, the second quick-release structure matching casing of the second antenna signal transmission structure is configured to be detachably connected to the first quick-release structure matching casing of the first antenna signal transmission structure, and the second quick-release signal transmission assembly of the second antenna signal transmission structure is configured to be detachably connected to the first quick-release signal transmission assembly of the first antenna signal transmission structure.

Therefore, in the quick-detachable antenna signal transmission module provided by the present disclosure, by virtue of “the first antenna signal transmission structure including a first quick-release structure matching casing and a first quick-release signal transmission assembly partially enclosed by the first quick-release structure matching casing” and “the second antenna signal transmission structure including a second quick-release structure matching casing and a second quick-release signal transmission assembly partially enclosed by the second quick-release structure matching casing,” when the first quick-release structure matching casing of the first antenna signal transmission structure is configured to be fixed on an electronic product housing, the second quick-release structure matching casing of the second antenna signal transmission structure is configured to be detachably connected to the first quick-release structure matching casing of the first antenna signal transmission structure, and the second quick-release signal transmission assembly of the second antenna signal transmission structure is configured to be detachably connected to the first quick-release signal transmission assembly of the first antenna signal transmission structure.

Furthermore, in the method for manufacturing the quick-detachable antenna signal transmission module provided by the present disclosure, by virtue of “making a first antenna signal transmission structure that includes a first quick-release structure matching casing and a first quick-release signal transmission assembly partially enclosed by the first quick-release structure matching casing,” “making a second antenna signal transmission structure that includes a second quick-release structure matching casing and a second quick-release signal transmission assembly partially enclosed by the second quick-release structure matching casing” and “detachably matching the first antenna signal transmission structure and the second antenna signal transmission structure with each other,” when the first quick-release structure matching casing of the first antenna signal transmission structure is configured to be fixed on an electronic product housing, the second quick-release structure matching casing of the second antenna signal transmission structure is configured to be detachably connected to the first quick-release structure matching casing of the first antenna signal transmission structure, and the second quick-release signal transmission assembly of the second antenna signal transmission structure is configured to be detachably connected to the first quick-release signal transmission assembly of the first antenna signal transmission structure.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective exploded view of a quick-detachable antenna signal transmission module provided by a first embodiment of the present disclosure;

FIG. 2 is another schematic perspective exploded view of the quick-detachable antenna signal transmission module provided by the first embodiment of the present disclosure;

FIG. 3 is a schematic perspective assembled view of the quick-detachable antenna signal transmission module provided by the first embodiment of the present disclosure;

FIG. 4 is a schematic cross-sectional view taken along line IV-IV of FIG. 3;

FIG. 5 is a schematic perspective exploded view of the quick-detachable antenna signal transmission module provided by a second embodiment of the present disclosure;

FIG. 6 is another schematic perspective exploded view of the quick-detachable antenna signal transmission module provided by the second embodiment of the present disclosure;

FIG. 7 is a schematic perspective assembled view of the quick-detachable antenna signal transmission module provided by the second embodiment of the present disclosure;

FIG. 8 is a schematic cross-sectional view taken along line VIII-VIII of FIG. 7;

FIG. 9 is a schematic perspective exploded view of the quick-detachable antenna signal transmission module provided by a third embodiment of the present disclosure;

FIG. 10 is another schematic perspective exploded view of the quick-detachable antenna signal transmission module provided by the third embodiment of the present disclosure;

FIG. 11 is a schematic perspective assembled view of the quick-detachable antenna signal transmission module provided by the third embodiment of the present disclosure;

FIG. 12 is a schematic cross-sectional view taken along line XII-XII of FIG. 11; and

FIG. 13 is a flowchart of a method for manufacturing the quick-detachable antenna signal transmission module provided by a fourth embodiment of the present disclosure.

### DETAILED DESCRIPTION OF THE EXEMPLARY EMBODIMENTS

The present disclosure is more particularly described in the following embodiments and examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” may include plural reference, and the meaning of “in” may include “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

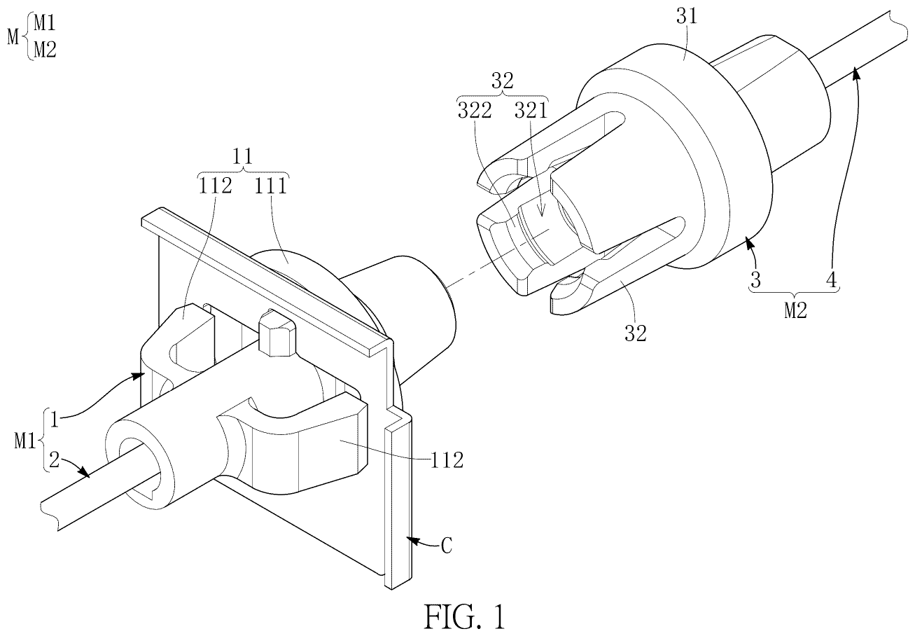

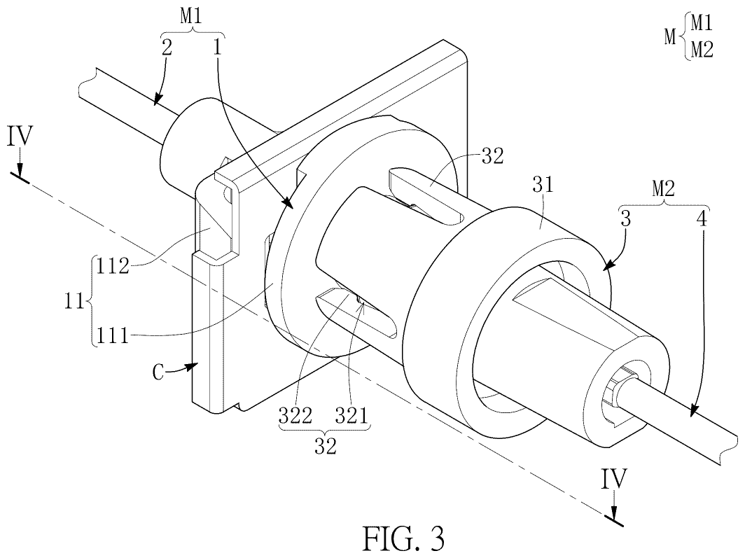

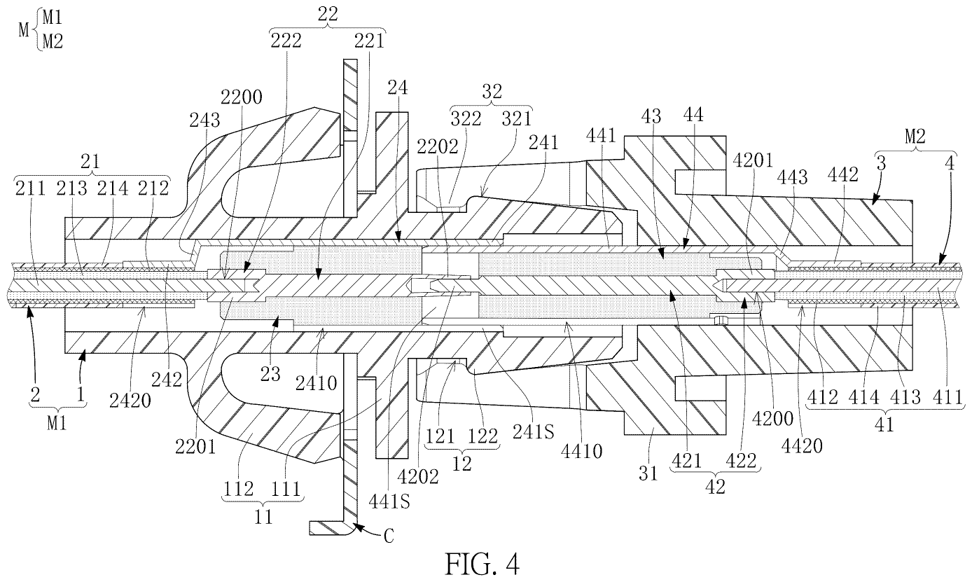

Referring to FIG. 1 to FIG. 4, a first embodiment of the present disclosure provides a quick-detachable antenna signal transmission module M for transmitting antenna signals, which may include a first antenna signal transmission structure M1 and a second antenna signal transmission structure M2. More particularly, the first antenna signal transmission structure M1 may include a first quick-release structure matching casing 1 (or a first snap-fit structure matching casing) and a first quick-release signal transmission assembly 2 (or a first snap-fit signal transmission assembly) partially enclosed (or surrounded) by the first quick-release structure matching casing 1, and the second antenna signal transmission structure M2 may include a second quick-release structure matching casing 3 (or a second snap-fit structure matching casing) and a second quick-release signal transmission assembly 4 (or a second snap-fit signal transmission assembly) partially enclosed (or surrounded) by the second quick-release structure matching casing 3. Therefore, referring to FIG. 3 and FIG. 4, when the first quick-release structure matching casing 1 of the first antenna signal transmission structure M1 can be configured to be fixed or positioned on an electronic product housing C (such as an external shell of a computer host, a server, a wireless router or any electronic product, or the external shell of any mechanical product), the second quick-release structure matching casing 3 of the second antenna signal transmission structure M2 can be configured to be detachably connected (or non-electrically connected) to the first quick-release structure matching casing 1 of the first antenna signal transmission structure M1, and the second quick-release signal transmission assembly 4 of the second antenna signal transmission structure M2 can be configured to be detachably connected (or electrically connected) to the first quick-release signal transmission assembly 2 of the first antenna signal transmission structure M1.

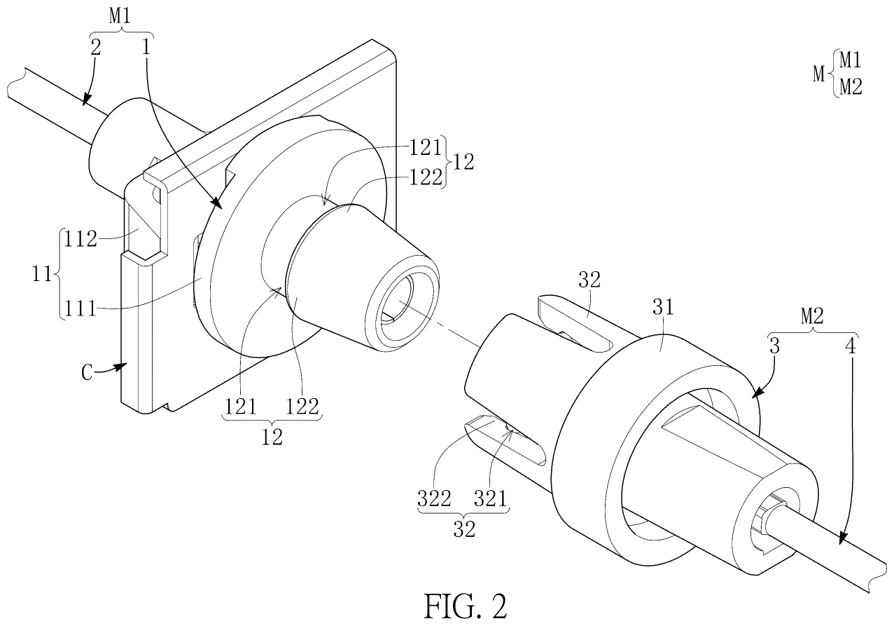

For example, in one of the feasible embodiments, referring to FIG. 1, FIG. 2 and FIG. 3, the first quick-release structure matching casing 1 may include a first structure body 11 and a plurality of first pluggable buckle matching portions 12 surroundingly connected to the first structure body 11 (FIG. 2 shows that the multiple first pluggable buckle matching portions 12 can be communicated with each other to form a surrounding fitting portion as an example), and the second quick-release structure matching casing 3 may include a second structure body 31 and a plurality of second pluggable buckle matching portions 32 surroundingly connected to the second structure body 31 (FIG. 2 shows that the multiple second pluggable buckle matching portions 32 can be separate from each other as an example). Therefore, referring to FIG. 3 and FIG. 4, when the second quick-release structure matching casing 3 of the second antenna signal transmission structure M2 can be configured to be detachably connected (structurally connected) to the first quick-release structure matching casing 1 of the first antenna signal transmission structure M1, the second pluggable buckle matching portions 32 of the second quick-release structure matching casing 3 can be configured to be pluggably connected to the first pluggable buckle matching portions 12 of the first quick-release structure matching casing 1 respectively. However, the aforementioned details are disclosed for exemplary purposes only, and are not meant to limit the scope of the present disclosure.

For example, in one of the feasible embodiments, referring to FIG. 1, FIG. 2 and FIG. 3, each of the first pluggable buckle matching portions 12 of the first quick-release structure matching casing 1 may include a first buckle groove 121 and a first buckle protrusion 122 connected to the first buckle groove 121 (FIG. 2 shows that the multiple first buckle grooves 121 of the multiple first pluggable buckle matching portions 12 can be communicated with each other to form a surrounding groove as an example, and the multiple first buckle protrusions 122 of the multiple first pluggable buckle matching portions 12 can be communicated with each other to form a surrounding protrusion), and each of the second pluggable buckle matching portions 32 of the second quick-release structure matching casing 3 may include a second buckle groove 321 and a second buckle protrusion 322 connected to the second buckle groove 321. Therefore, referring to FIG. 3 and FIG. 4, when the second pluggable buckle matching portions 32 of the second quick-release structure matching casing 3 can be configured to be pluggably connected to the first pluggable buckle matching portions 12 of the first quick-release structure matching casing 1 respectively (without using any additional disassembly tool), the second buckle grooves 321 of the second pluggable buckle matching portions 32 of the second quick-release structure matching casing 3 can be configured to pluggably accommodate (or receive) the first buckle protrusions 122 of the first pluggable buckle matching portions 12 of the first quick-release structure matching casing 1 respectively, and the second buckle protrusions 322 of the second pluggable buckle matching portions 32 of the second quick-release structure matching casing 3 can be configured to be pluggably accommodated (or received) in the first buckle grooves 121 of the first pluggable buckle matching portions 12 of the first quick-release structure matching casing 1 respectively. However, the aforementioned details are disclosed for exemplary purposes only, and are not meant to limit the scope of the present disclosure.

It should be noted that, for example, in one of the feasible embodiments, referring to FIG. 1, FIG. 2 and FIG. 3, the first structure body 11 of the first quick-release structure matching casing 1 may have a fixed position-limiting portion 111 (or a fixed portion) and a plurality of resilient position-limiting portions 112 (or a movable portion) separate from the fixed position-limiting portion 111. Therefore, referring to FIG. 3 and FIG. 4, when the first quick-release structure matching casing 1 of the first antenna signal transmission structure M1 can be configured to be fixed on the electronic product housing C, the first structure body 11 of the first quick-release structure matching casing 1 can pass through the electronic product housing C to restrict or limit (or position) the electronic product housing C between the fixed position-limiting portion 111 and each of the resilient position-limiting portions 112 (that is to say, the first antenna signal transmission structure M1 can be positioned on the electronic product housing C through cooperation of the fixed position-limiting portion 111 and the resilient position-limiting portions 112). However, the aforementioned details are disclosed for exemplary purposes only, and are not meant to limit the scope of the present disclosure.

It should be noted that, for example, in one of the feasible embodiments, when the first embodiment of the present disclosure can simultaneously use more than two first antenna signal transmission structures M1 and more than two second antenna signal transmission structures M2, the first quick-release structure matching casing 1 of any one of the first antenna signal transmission structures M1 can be detachably connected (snap-fitted) to another first quick-release structure matching casing 1 of another first antenna signal transmission structure M1 through two adjacent first snap-fit portions that are respectively provided by two adjacent first antenna signal transmission structures M1 (thereby achieving the effect of quickly splicing or assembling more than two first antenna signal transmission structures M1), and the second quick-release structure matching casing 3 of any one of the second antenna signal transmission structures M2 can be detachably connected to another second quick-release structure matching casing 3 of another second antenna signal transmission structure M2 through two adjacent second snap-fitting portions that are respectively provided by two adjacent second antenna signal transmission structures M2 (thereby achieving the effect of quickly splicing or assembling more than two second antenna signal transmission structures M2). However, the aforementioned details are disclosed for exemplary purposes only, and are not meant to limit the scope of the present disclosure.

More particularly, referring to FIG. 3 and FIG. 4, the first quick-release signal transmission assembly 2 of the first antenna signal transmission structure M1 may further include a first signal transmission cable 21, a first signal transmission element 22, a first insulating covering element 23 (or a first insulating sheath element) and a first external grounding element 24, and the second quick-release signal transmission assembly 4 of the second antenna signal transmission structure M2 may further include a second signal transmission cable 41, a second signal transmission element 42, a second insulating covering element 43 (or a second insulating sheath element) and a second external grounding element 44.

For example, in one of the feasible embodiments, referring to FIG. 3 and FIG. 4, the first signal transmission cable 21 may include a first conductive layer 211 and a first grounding layer 212 that are separate from each other, the second signal transmission cable 41 may include a second conductive layer 411 and a second grounding layer 412 that are separate from each other, and the first signal transmission cable 21 and the second signal transmission cable 41 can be any type of coaxial cable or any type of conductive wire structure. Moreover, when the first signal transmission cable 21 can be any type of coaxial cable, the first signal transmission cable 21 may include a first inner insulating layer 213 for covering or enclosing the first conductive layer 211 and a first outer insulating layer 214 for covering or enclosing the first grounding layer 212, and the first inner insulating layer 213 can be disposed between the first conductive layer 211 and the first grounding layer 212 so as to insulate the first conductive layer 211 and the first grounding layer 212 from each other. In addition, when the second signal transmission cable 41 can be any type of coaxial cable, the second signal transmission cable 41 may include a second inner insulating layer 413 for covering or enclosing the second conductive layer 411 and a second outer insulating layer 414 for covering or enclosing the second grounding layer 412, and the second inner insulating layer 413 can be disposed between the second conductive layer 411 and the second grounding layer 412 so as to insulate the second conductive layer 411 and the second grounding layer 412 from each other. However, the aforementioned details are disclosed for exemplary purposes only, and are not meant to limit the scope of the present disclosure.

For example, in one of the feasible embodiments, referring to FIG. 3 and FIG. 4, a first side portion 2201 of the first signal transmission element 22 can electrically contact the first conductive layer 211 of the first signal transmission cable 21, and the first insulating covering element 23 can partially and surroundingly cover (or enclose) the first signal transmission element 22. More particularly, the first signal transmission element 22 can be a conductive core rod made of any kind of conductive material, and the first insulating covering element 23 can be an insulating cover made of any kind of insulating material (such as Teflon® or any kind of plastic material). Moreover, a portion of the first conductive layer 211 of the first signal transmission cable 21 can be inserted into the first side portion 2201 of the first signal transmission element 22 (that is to say, the first signal transmission element 22 may have a first accommodation portion 2200 for covering or enclosing a portion of the first conductive layer 211 of the first signal transmission cable 21), and the first conductive layer 211 of the first signal transmission cable 21 can be electrically connected to the first side portion 2201 of the first signal transmission element 22 by welding or tight fitting. In addition, the first signal transmission element 22 may have a first embedded extension section 221 and a first exposed protruding section 222 connected to the first embedded extension section 221, and the first insulating covering element 23 can be configured to cover or enclose the first embedded extension section 221 and abut against the first exposed protruding section 222, thereby limiting or restricting a position of the first signal transmission element 22 relative to the first insulating covering element 23. However, the aforementioned details are disclosed for exemplary purposes only, and are not meant to limit the scope of the present disclosure.

For example, in one of the feasible embodiments, referring to FIG. 3 and FIG. 4, a first side portion 4201 of the second signal transmission element 42 can electrically contact the second conductive layer 411 of the second signal transmission cable 41, and the second insulating covering element 43 can partially and surroundingly cover (or enclose) the second signal transmission element 42. More particularly, the first signal transmission element 22 can be a conductive core rod made of any kind of conductive material, and the first insulating covering element 23 can be an insulating cover made of any kind of insulating material (such as Teflon® or any kind of plastic material). Moreover, a portion of the second conductive layer 411 of the second signal transmission cable 41 can be inserted into the first side portion 4201 of the second signal transmission element 42 (that is to say, the second signal transmission element 42 may have a second accommodation portion 4200 for covering or enclosing a portion of the second conductive layer 411 of the second signal transmission cable 41), and the second conductive layer 411 of the second signal transmission cable 41 can be electrically connected to the first side portion 4201 of the second signal transmission element 42 by welding or tight fitting. In addition, the second signal transmission element 42 may have a second embedded extension section 421 and a second exposed protruding section 422 connected to the second embedded extension section 421, and the second insulating covering element 43 can be configured to cover or enclose the second embedded extension section 421 and abut against the second exposed protruding section 422, thereby limiting or restricting a position of the second signal transmission element 42 relative to the second insulating covering element 43. However, the aforementioned details are disclosed for exemplary purposes only, and are not meant to limit the scope of the present disclosure.

For example, in one of the feasible embodiments, referring to FIG. 3 and FIG. 4, the first external grounding element 24 may include a first front covering portion 241 for partially and surroundingly covering the first insulating covering element 23, a first rear covering portion 242 for partially and surroundingly covering the first grounding layer 212 of the first signal transmission cable 21, and a first middle connecting portion 243 connected between the first front covering portion 241 and the first rear covering portion 242. In addition, the second external grounding element 44 may include a second front covering portion 441 for partially and surroundingly covering the second insulating covering element 43, a second rear covering portion 442 for partially and surroundingly covering the second grounding layer 412 of the second signal transmission cable 41, and a second middle connecting portion 443 connected between the second front covering portion 441 and the second rear covering portion 442. More particularly, the first front covering portion 241 of the first external grounding element 24 may have a first front slit 2410 for partially exposing the first insulating covering element 23, and the first rear covering portion 242 of the first external grounding element 24 may have a first rear slit 2420 for partially exposing the first grounding layer 212 of the first signal transmission cable 21. In addition, the second front covering portion 441 of the second external grounding element 44 may have a second front slit 4410 for partially exposing the second insulating covering element 43, and the second rear covering portion 442 of the second external grounding element 44 may have a second rear slit 4420 for partially exposing the second grounding layer 412 of the second signal transmission cable 41. However, the aforementioned details are disclosed for exemplary purposes only, and are not meant to limit the scope of the present disclosure.

For example, in one of the feasible embodiments, referring to FIG. 3 and FIG. 4, a portion of the first external grounding element 24 and a portion of the first signal transmission cable 21 can be enclosed or surrounded by a first quick-release structure matching casing 1, a portion of the second external grounding element 44 and a portion of the second signal transmission cable 41 can be enclosed or surrounded by a second quick-release structure matching casing 3, and the first quick-release structure matching casing 1 and the second quick-release structure matching casing 3 can be detachably matched with each other through a buckle structure or any matching structure. However, the aforementioned details are disclosed for exemplary purposes only, and are not meant to limit the scope of the present disclosure.

For example, in one of the feasible embodiments, referring to FIG. 1, FIG. 2 and FIG. 4, when the first quick-release structure matching casing 1 and the second quick-release structure matching casing 3 can be separated from each other (or when the first antenna signal transmission structure M1 and the second antenna signal transmission structure M2 can be separated from each other), the second side portion 2202 of the first signal transmission element 22 and the second side portion 4202 of the second signal transmission element 42 can be separated from each other, and a first quick-release matching portion 241S of the first front covering portion 241 of the first external grounding element 24 and a second quick-release matching portion 441S of the second front covering portion 441 of the second external grounding element 44 can be separated from each other. However, the aforementioned details are disclosed for exemplary purposes only, and are not meant to limit the scope of the present disclosure.

For example, in one of the feasible embodiments, referring to FIG. 3 and FIG. 4, when the first quick-release structure matching casing 1 and the second quick-release structure matching casing 3 can be matched with each other (or when the first antenna signal transmission structure M1 and the second antenna signal transmission structure M2 can be matched with each other), the second side portion 4202 of the second signal transmission element 42 can be enclosed or surrounded by the second side portion 2202 of the first signal transmission element 22 (or the second side portion 2202 of the first signal transmission element 22 can be enclosed or surrounded by the second side portion 4202 of the second signal transmission element 42), and the second quick-release matching portion 441S of the second front covering portion 441 of the second external grounding element 44 can be enclosed or surrounded by the first quick-release matching portion 241S of the first front covering portion 241 of the first external grounding element 24 (or the first quick-release matching portion 241S of the first front covering portion 241 of the first external grounding element 24 can be enclosed or surrounded by the second quick-release matching portion 441S of the second front covering portion 441 of the second external grounding element 44). However, the aforementioned details are disclosed for exemplary purposes only, and are not meant to limit the scope of the present disclosure.

For example, in one of the feasible embodiments, referring to FIG. 3 and FIG. 4, when the first quick-release structure matching casing 1 and the second quick-release structure matching casing 3 can be matched with each other (or when the first antenna signal transmission structure M1 and the second antenna signal transmission structure M2 can be matched with each other), the second side portion 2202 of the first signal transmission element 22 and the second side portion 4202 of the second signal transmission element 42 can be tightly matched with each other, and the first quick-release matching portion 241S of the first front covering portion 241 of the first external grounding element 24 and the second quick-release matching portion 441S of the second front covering portion 441 of the second external grounding element 44 can be tightly matched with each other. It should be noted that referring to FIG. 3 and FIG. 4, when the first quick-release structure matching casing 1 and the second quick-release structure matching casing 3 can be matched with each other (or when the first antenna signal transmission structure M1 and the second antenna signal transmission structure M2 can be matched with each other), the first insulating covering element 23 and the second insulating covering element 43 can be separated from each other, and an outer surrounding surface of the first insulating covering element 23 and an outer surrounding surface of the second front covering portion 441 of the second external grounding element 44 can be aligned or flush with each other. However, the aforementioned details are disclosed for exemplary purposes only, and are not meant to limit the scope of the present disclosure.

Therefore, referring to FIG. 3 and FIG. 4, when the first quick-release structure matching casing 1 and the second quick-release structure matching casing 3 can be matched with each other (or when the first antenna signal transmission structure M1 and the second antenna signal transmission structure M2 can be matched with each other), a second side portion 2202 of the first signal transmission element 22 and a second side portion 4202 of the second signal transmission element 42 can be pluggably matched with each other, and the first quick-release matching portion 241S of the first front covering portion 241 of the first external grounding element 24 and the second quick-release matching portion 441S of the second front covering portion 441 of the second external grounding element 44 can be pluggably matched with each other.

It should be noted that, for example, in one of the feasible embodiments, referring to FIG. 3 and FIG. 4, when the first quick-release structure matching casing 1 and the second quick-release structure matching casing 3 can be matched with each other (or when the first antenna signal transmission structure M1 and the second antenna signal transmission structure M2 can be matched with each other), the first signal transmission cable 21 and the second signal transmission cable 41 can be electrically connected between a circuit substrate (or a control module) and an antenna structure (or an antenna module, or an antenna system). That is to say, according to different requirements, the first signal transmission cable 21 can be electrically connected to one of the circuit substrate and the antenna structure, and the second signal transmission cable 41 can be electrically connected to another one of the circuit substrate and the antenna structure. Therefore, the antenna signal (RF signal) can be transmitted between the circuit substrate and the antenna structure through cooperation of the first signal transmission element 22 and the second signal transmission element 42, and the antenna structure can be electrically connected to a grounding area (not shown) of the circuit substrate through cooperation of the first external grounding element 24 and the second external grounding element 44. However, the aforementioned details are disclosed for exemplary purposes only, and are not meant to limit the scope of the present disclosure.

It should be noted that, for example, as shown in FIG. 4, the first inner insulating layer 213 of the first signal transmission cable 21 has a first uncovered area that is not covered by the first grounding layer 212. The present disclosure can control the length of the first uncovered area of the first inner insulating layer 213 to be less than 0.3 mm, thereby increasing the upper limit value of the working frequency band (or the operating frequency band) of the quick-detachable antenna signal transmission module M, so that the return loss (S11) of the working frequency band of the quick-detachable antenna signal transmission module M within the range of 18 GHz can be less than- 10 dB. In other words, when the length of the first middle connecting portion 243 connected between the first front covering portion 241 and the first rear covering portion 242 is shortened to less than 0.7 mm, the upper limit value of the working frequency band (or the operating frequency band) of the quick-detachable antenna signal transmission module M can also be increased, so that the return loss (S11) of the working frequency band of the quick-detachable antenna signal transmission module M within the range of 18 GHz can be less than −10 dB. Based on the same principle as above, as shown in FIG. 4, the second inner insulating layer 413 of the second signal transmission cable 41 has a second uncovered area that is not covered by the second grounding layer 412. The present disclosure can control the length of the second uncovered area of the second inner insulating layer 413 to be less than 0.3 mm, thereby increasing the upper limit value of the working frequency band (or the operating frequency band) of the quick-detachable antenna signal transmission module M, so that the return loss (S11) of the working frequency band of the quick-detachable antenna signal transmission module M within the range of 18 GHz can be less than −10 dB. In other words, when the length of the second middle connecting portion 443 connected between the second front covering portion 441 and the second rear covering portion 442 is shortened to less than 0.7 mm, the upper limit value of the working frequency band (or the operating frequency band) of the quick-detachable antenna signal transmission module M can be increased, so that the return loss (S11) of the working frequency band of the quick-detachable antenna signal transmission module M within the range of 18 GHz can be less than −10 dB. However, the aforementioned details are disclosed for exemplary purposes only, and are not meant to limit the scope of the present disclosure.

### Second Embodiment

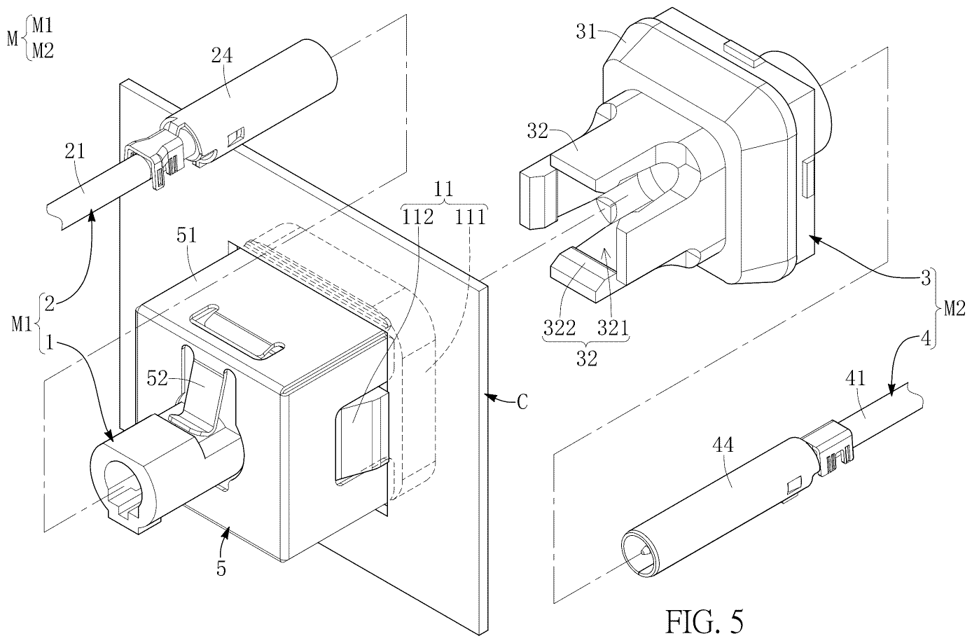

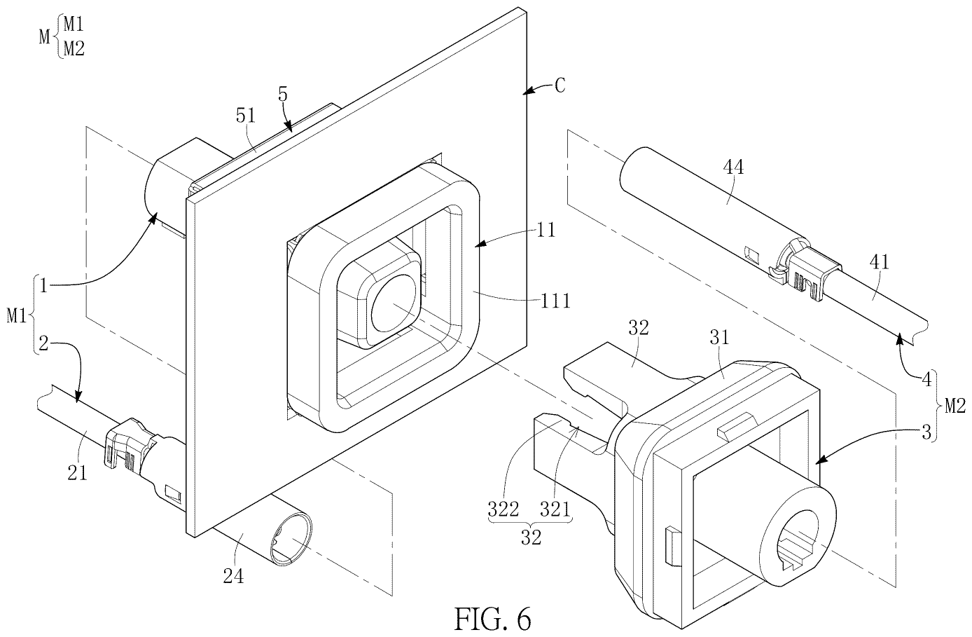

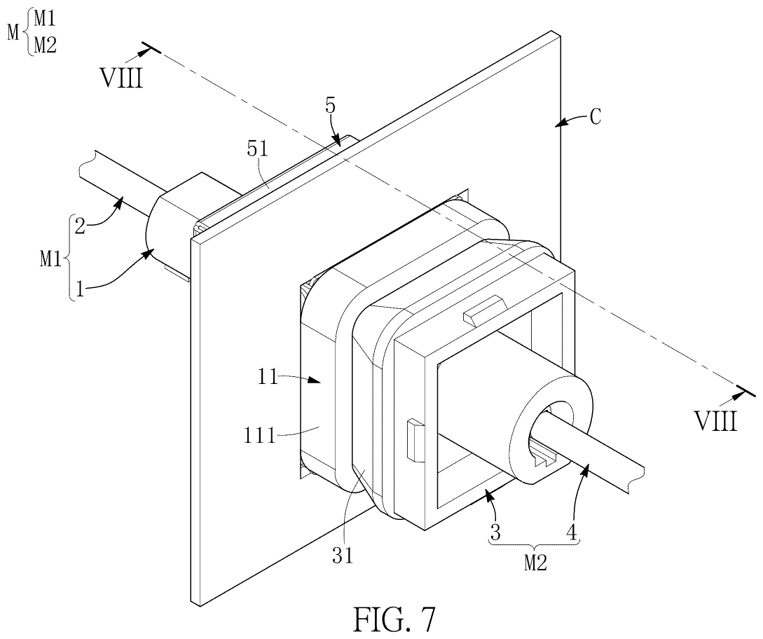

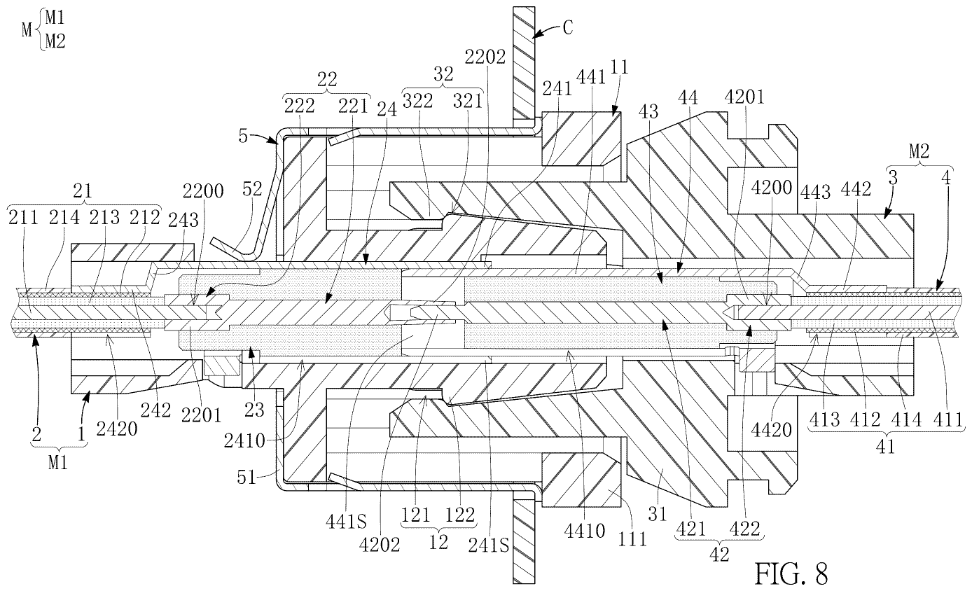

Referring to FIG. 5 to FIG. 8, a second embodiment of the present disclosure provides a quick-detachable antenna signal transmission module M for transmitting antenna signals, which may include a first antenna signal transmission structure M1 and a second antenna signal transmission structure M2. By comparing FIG. 5 to FIG. 8 with FIG. 1 to FIG. 4 respectively, the main difference between the second embodiment and the first embodiment is as follows: in the second embodiment, the first antenna signal transmission structure M1 may further include a detachable grounding cover 5 that can be detachably disposed on the first quick-release structure matching casing 1 and electrically connected to the first quick-release signal transmission assembly 2, and the second antenna signal transmission structure M2 may further include another detachable grounding cover that can be detachably disposed on the second quick-release structure matching casing 3 and electrically connected to the second quick-release signal transmission assembly 4. For example, in one of the feasible embodiments, the detachable grounding cover 5 may include a grounding shell portion 51 (or an exposed grounding portion) and a grounding guide portion 52, the grounding shell portion 51 can be detachably disposed on the first quick-release structure matching casing 1, and the grounding guide portion 52 can be connected to the grounding shell portion 51 and electrically contact the first external grounding element 24 of the first quick-release signal transmission assembly 2. In addition, in one of the feasible embodiments, the another detachable grounding cover may include another grounding shell portion (or another exposed grounding portion) and another grounding guide portion, the another grounding shell portion can be detachably disposed on the second quick-release structure matching casing 3, and the another grounding guide portion can be connected to the another grounding shell portion and electrically contact the second external grounding element 44 of the second quick-release signal transmission assembly 4. It should be noted that referring to FIG. 6 and FIG. 7, in the second embodiment, the second pluggable buckle matching portions 32 of the second quick-release structure matching casing 3 can be surrounded and limited by the fixed position-limiting portion 111 of the first structure body 11 of the first quick-release structure matching casing 1, thereby strengthening the matching relationship between the first quick-release structure matching casing 1 of the first antenna signal transmission structure M1 and the second quick-release structure matching casing 3 of the second antenna signal transmission structure M2. However, the aforementioned details are disclosed for exemplary purposes only, and are not meant to limit the scope of the present disclosure.

### Third Embodiment

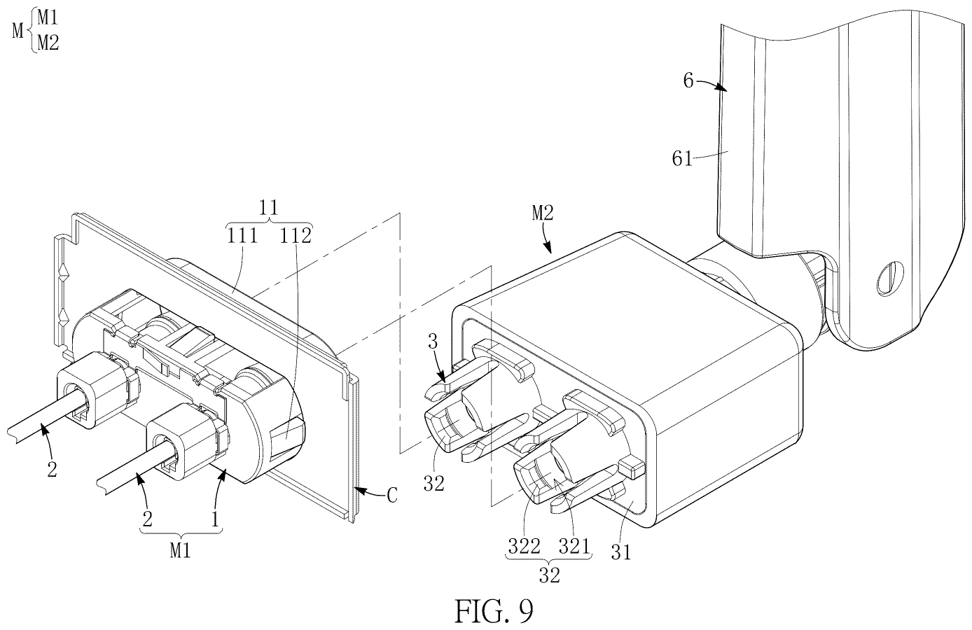

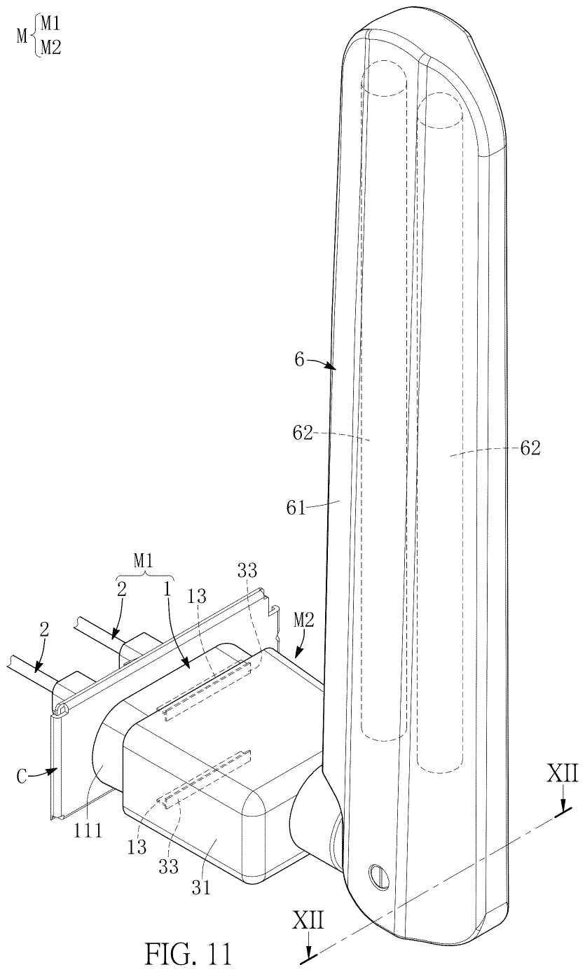

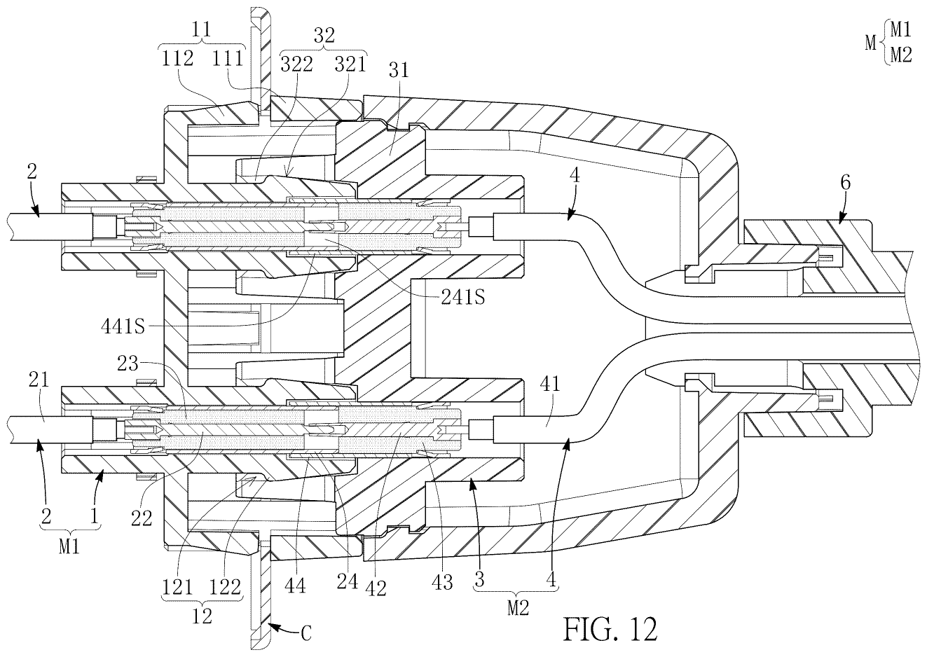

Referring to FIG. 9 to FIG. 12, a third embodiment of the present disclosure provides a quick-detachable antenna signal transmission module M for transmitting antenna signals, which may include a first antenna signal transmission structure M1 and a second antenna signal transmission structure M2. By comparing FIG. 9 to FIG. 12 with FIG. 1 to FIG. 4 respectively, the main difference between the third embodiment and the first embodiment (or the second embodiment) is as follows: in the third embodiment, the second antenna signal transmission structure M2 may further include an external antenna assembly 6 (or an exposed antenna assembly) that can be pivotally connected to the second quick-release structure matching casing 3 and electrically connected to the second quick-release signal transmission assembly 4. Moreover, the first antenna signal transmission structure M1 may include another first quick-release signal transmission assembly 2 partially enclosed or surrounded by the first quick-release structure matching casing 1, and the two first quick-release signal transmission assemblies 2 can be separate from each other. In addition, the second antenna signal transmission structure M2 may include another second quick-release signal transmission assembly 4 partially enclosed or surrounded by the second quick-release structure matching casing 3, and the two second quick-release signal transmission assemblies 4 can be separate from each other. For example, in one of the feasible embodiments, the external antenna assembly 6 may include an antenna shell portion 61 pivotally connected to the second quick-release structure matching casing 3 and at least one antenna structure portion 62 disposed in the antenna shell portion 61 and electrically connected to the second quick-release signal transmission assembly 4 (FIG. 11 shows two antenna structure portions 62 electrically connected to two second quick-release signal transmission assemblies 4 respectively as an example).

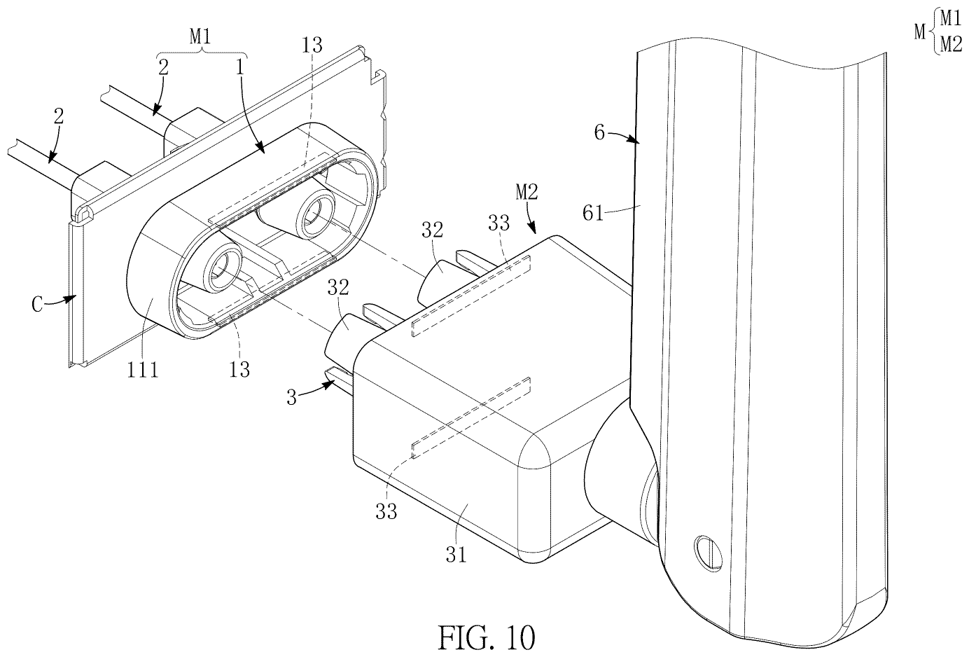

It should be noted that, for example, in one of the feasible embodiments, referring to FIG. 10 and FIG. 11, the first quick-release structure matching casing 1 may include at least one first magnetic member 13 (FIG. 10 and FIG. 11 show two first magnetic members 13 as an example), and the second quick-release structure matching casing 3 may include at least one second magnetic member 33 (FIG. 10 and FIG. 11 show two second magnetic members 33 as an example). Therefore, when the first antenna signal transmission structure M1 and the second antenna signal transmission structure M2 can be matched with each other, the at least one first magnetic member 13 (such as two first magnets) disposed on the first quick-release structure matching casing 1 and the at least one second magnetic member 33 (such as two second magnets) disposed on the second quick-release structure matching casing 3 can be magnetically attracted to each other, thereby improving the matching strength, matching tightness or matching stability of the first quick-release structure matching casing 1 and the second quick-release structure matching casing 3.

### Fourth Embodiment

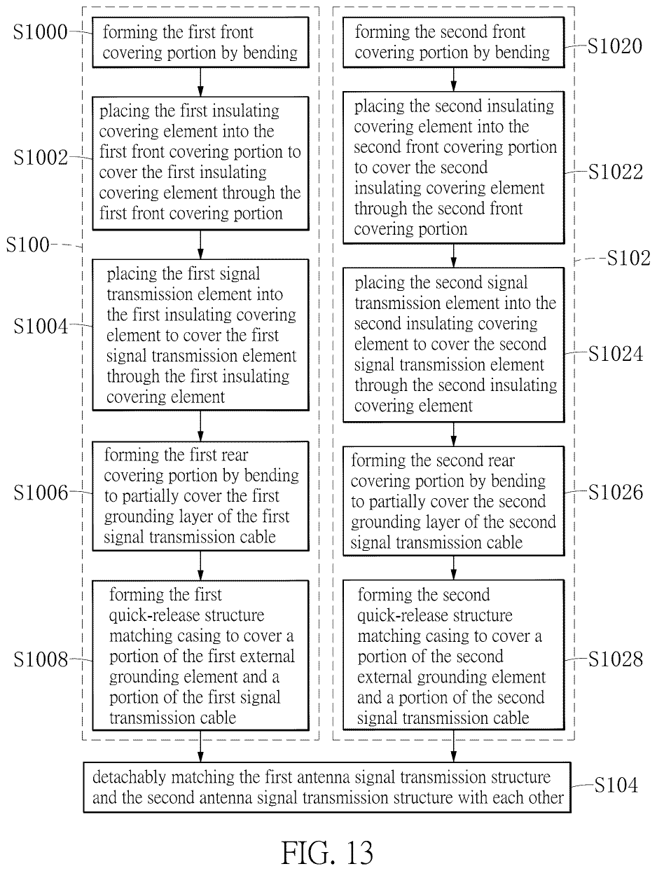

Referring to FIG. 1 to FIG. 13, a fourth embodiment of the present disclosure provides a method for manufacturing a quick-detachable antenna signal transmission module M, which may include the following steps: firstly, making a first antenna signal transmission structure M1, in which the first antenna signal transmission structure M1 may include a first quick-release structure matching casing 1 and a first quick-release signal transmission assembly 2 partially enclosed by the first quick-release structure matching casing 1 (step S100); next, making a second antenna signal transmission structure M2, in which the second antenna signal transmission structure M2 may include a second quick-release structure matching casing 3 and a second quick-release signal transmission assembly 4 partially enclosed by the second quick-release structure matching casing 3 (step S102); and detachably matching the first antenna signal transmission structure M1 and the second antenna signal transmission structure M2 with each other (step S104). Therefore, referring to FIG. 3 and FIG. 4, when the first quick-release structure matching casing 1 of the first antenna signal transmission structure M1 can be configured to be fixed or positioned on an electronic product housing C (such as an external shell of a computer host, a server, a wireless router or any electronic product, or the external shell of any mechanical product), the second quick-release structure matching casing 3 of the second antenna signal transmission structure M2 can be configured to be detachably connected (or non-electrically connected) to the first quick-release structure matching casing 1 of the first antenna signal transmission structure M1, and the second quick-release signal transmission assembly 4 of the second antenna signal transmission structure M2 can be configured to be detachably connected (or electrically connected) to the first quick-release signal transmission assembly 2 of the first antenna signal transmission structure M1. It should be noted that when the first antenna signal transmission structure M1 and the second antenna signal transmission structure M2 can be separated from each other, a second side portion 2202 of the first signal transmission element 22 and a second side portion 4202 of the second signal transmission element 42 can be separated from each other, the first insulating covering element 23 and the second insulating covering element 43 can be separated from each other, and a first quick-release matching portion 241S of the first front covering portion 241 of the first external grounding element 24 and a second quick-release matching portion 441S of the second front covering portion 441 of the second external grounding element 44 can be separated from each other.

More particularly, the step S100 of making the first antenna signal transmission structure M1 may further include: firstly, forming the first front covering portion 241 by bending (step S1000); next, placing the first insulating covering element 23 into the first front covering portion 241 so as to cover or enclose the first insulating covering element 23 through the first front covering portion 241 (step S1002); then, placing the first signal transmission element 22 into the first insulating covering element 23 so as to cover or enclose the first signal transmission element 22 through the first insulating covering element 23 (step S1004); next, forming the first rear covering portion 242 by bending to partially cover or enclose the first grounding layer 212 of the first signal transmission cable 21 (step S1006); and forming the first quick-release structure matching casing 1 to cover or enclose a portion of the first external grounding element 24 and a portion of the first signal transmission cable 21 (step S1008).

More particularly, the step S102 of making the second antenna signal transmission structure M2 may further include: firstly, forming the second front covering portion 441 by bending (step S1020); next, placing the second insulating covering element 43 into the second front covering portion 441 so as to cover or enclose the second insulating covering element 43 through the second front covering portion 441 (step S1022); then, placing the second signal transmission element 42 into the second insulating covering element 43 so as to cover or enclose the second signal transmission element 42 through the second insulating covering element 43 (step S1024); next, forming the second rear covering portion 442 by bending to partially cover or enclose the second grounding layer 412 of the second signal transmission cable 41 (step S1026); and forming the second quick-release structure matching casing 3 to cover or enclose a portion of the second external grounding element 44 and a portion of the second signal transmission cable 41 (step S1028).

More particularly, the first antenna signal transmission structure M1 and the second antenna signal transmission structure M2 can be in electrical contact with each other by pluggably matching the first quick-release structure matching casing 1 and the second quick-release structure matching casing 3 with each other. Therefore, the antenna signal (RF signal) can be transmitted between a circuit substrate and an antenna structure through cooperation of the first signal transmission element 22 and the second signal transmission element 42.

### Beneficial Effects of the Embodiments

In conclusion, in the quick-detachable antenna signal transmission module M provided by the present disclosure, by virtue of “the first antenna signal transmission structure M1 including a first quick-release structure matching casing 1 and a first quick-release signal transmission assembly 2 partially enclosed by the first quick-release structure matching casing 1” and “the second antenna signal transmission structure M2 including a second quick-release structure matching casing 3 and a second quick-release signal transmission assembly 4 partially enclosed by the second quick-release structure matching casing 3,” when the first quick-release structure matching casing 1 of the first antenna signal transmission structure M1 can be configured to be fixed on an electronic product housing C, the second quick-release structure matching casing 3 of the second antenna signal transmission structure M2 can be configured to be detachably connected to the first quick-release structure matching casing 1 of the first antenna signal transmission structure M1, and the second quick-release signal transmission assembly 4 of the second antenna signal transmission structure M2 can be configured to be detachably connected to the first quick-release signal transmission assembly 2 of the first antenna signal transmission structure M1.

Furthermore, in the method for manufacturing the quick-detachable antenna signal transmission module M provided by the present disclosure, by virtue of “making a first antenna signal transmission structure M1 that may include a first quick-release structure matching casing 1 and a first quick-release signal transmission assembly 2 partially enclosed by the first quick-release structure matching casing 1,” “making a second antenna signal transmission structure M2 that may include a second quick-release structure matching casing 3 and a second quick-release signal transmission assembly 4 partially enclosed by the second quick-release structure matching casing 3” and “detachably matching the first antenna signal transmission structure M1 and the second antenna signal transmission structure M2 with each other,” when the first quick-release structure matching casing 1 of the first antenna signal transmission structure M1 can be configured to be fixed on an electronic product housing C, the second quick-release structure matching casing 3 of the second antenna signal transmission structure M2 can be configured to be detachably connected to the first quick-release structure matching casing 1 of the first antenna signal transmission structure M1, and the second quick-release signal transmission assembly 4 of the second antenna signal transmission structure M2 can be configured to be detachably connected to the first quick-release signal transmission assembly 2 of the first antenna signal transmission structure M1.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A quick-detachable antenna signal transmission module, comprising:
a first antenna signal transmission structure including a first quick-release structure matching casing and a first quick-release signal transmission assembly partially enclosed by the first quick-release structure matching casing; and
a second antenna signal transmission structure including a second quick-release structure matching casing and a second quick-release signal transmission assembly partially enclosed by the second quick-release structure matching casing;
wherein, when the first quick-release structure matching casing of the first antenna signal transmission structure is configured to be fixed on an electronic product housing, the second quick-release structure matching casing of the second antenna signal transmission structure is configured to be detachably connected to the first quick-release structure matching casing of the first antenna signal transmission structure, and the second quick-release signal transmission assembly of the second antenna signal transmission structure is configured to be detachably connected to the first quick-release signal transmission assembly of the first antenna signal transmission structure.

2. The quick-detachable antenna signal transmission module according to claim 1,
wherein the first quick-release structure matching casing includes a first structure body and a plurality of first pluggable buckle matching portions surroundingly connected to the first structure body;
wherein the second quick-release structure matching casing includes a second structure body and a plurality of second pluggable buckle matching portions surroundingly connected to the second structure body;
wherein, when the second quick-release structure matching casing of the second antenna signal transmission structure is configured to be detachably connected to the first quick-release structure matching casing of the first antenna signal transmission structure, the plurality of second pluggable buckle matching portions of the second quick-release structure matching casing are configured to be pluggably connected to the plurality of first pluggable buckle matching portions of the first quick-release structure matching casing respectively;
wherein each of the plurality of first pluggable buckle matching portions of the first quick-release structure matching casing includes a first buckle groove and a first buckle protrusion connected to the first buckle groove;
wherein each of the plurality of second pluggable buckle matching portions of the second quick-release structure matching casing includes a second buckle groove and a second buckle protrusion connected to the second buckle groove;
wherein, when the plurality of second pluggable buckle matching portions of the second quick-release structure matching casing are configured to be pluggably connected to the plurality of first pluggable buckle matching portions of the first quick-release structure matching casing respectively, the plurality of second buckle grooves of the plurality of second pluggable buckle matching portions of the second quick-release structure matching casing are configured to pluggably accommodate the plurality of first buckle protrusions of the plurality of first pluggable buckle matching portions of the first quick-release structure matching casing respectively, and the plurality of second buckle protrusions of the plurality of second pluggable buckle matching portions of the second quick-release structure matching casing are configured to be pluggably accommodated in the plurality of first buckle grooves of the plurality of first pluggable buckle matching portions of the first quick-release structure matching casing respectively;
wherein the first quick-release structure matching casing includes at least one first magnetic member, and the second quick-release structure matching casing includes at least one second magnetic member;
wherein, when the first antenna signal transmission structure and the second antenna signal transmission structure are matched with each other, the at least one first magnetic member disposed on the first quick-release structure matching casing and the at least one second magnetic member disposed on the second quick-release structure matching casing are magnetically attracted to each other;
wherein the first structure body of the first quick-release structure matching casing has a fixed position-limiting portion and a plurality of resilient position-limiting portions separate from the fixed position-limiting portion;
wherein, when the first quick-release structure matching casing of the first antenna signal transmission structure is configured to be fixed on the electronic product housing, the first structure body of the first quick-release structure matching casing passes through the electronic product housing to restrict the electronic product housing between the fixed position-limiting portion and each of the plurality of resilient position-limiting portions;
wherein the first antenna signal transmission structure further includes a detachable grounding cover, the detachable grounding cover is detachably disposed on the first quick-release structure matching casing and electrically connected to the first quick-release signal transmission assembly;
wherein the detachable grounding cover includes a grounding shell portion detachably disposed on the first quick-release structure matching casing and a grounding guide portion connected to the grounding shell portion and electrically contacting the first quick-release signal transmission assembly;
wherein the second antenna signal transmission structure further includes an external antenna assembly pivotally connected to the second quick-release structure matching casing and electrically connected to the second quick-release signal transmission assembly;
wherein the external antenna assembly includes an antenna shell portion pivotally connected to the second quick-release structure matching casing and at least one antenna structure portion disposed in the antenna shell portion and electrically connected to the second quick-release signal transmission assembly;
wherein the first quick-release structure matching casing of the first antenna signal transmission structure is detachably connected to another first quick-release structure matching casing of another first antenna signal transmission structure;
wherein the second quick-release structure matching casing of the second antenna signal transmission structure is detachably connected to another second quick-release structure matching casing of another second antenna signal transmission structure;
wherein the first antenna signal transmission structure includes another first quick-release signal transmission assembly partially enclosed by the first quick-release structure matching casing, and the two first quick-release signal transmission assemblies are separate from each other; and
wherein the second antenna signal transmission structure includes another second quick-release signal transmission assembly partially enclosed by the second quick-release structure matching casing, and the two second quick-release signal transmission assemblies are separate from each other.

3. The quick-detachable antenna signal transmission module according to claim 1,
wherein the first quick-release signal transmission assembly of the first antenna signal transmission structure further includes: a first signal transmission cable, a first signal transmission element, a first insulating covering element and a first external grounding element, the first signal transmission cable includes a first conductive layer and a first grounding layer separate from each other, a first side portion of the first signal transmission element electrically contacts the first conductive layer of the first signal transmission cable, the first insulating covering element partially and surroundingly covers the first signal transmission element, and the first external grounding element includes a first front covering portion for partially and surroundingly covering the first insulating covering element, a first rear covering portion for partially and surroundingly covering the first grounding layer of the first signal transmission cable, and a first middle connecting portion connected between the first front covering portion and the first rear covering portion;
wherein the second quick-release signal transmission assembly of the second antenna signal transmission structure further includes: a second signal transmission cable, a second signal transmission element, a second insulating covering element and a second external grounding element, the second signal transmission cable includes a second conductive layer and a second grounding layer separate from each other, a first side portion of the second signal transmission element electrically contacts the second conductive layer of the second signal transmission cable, the second insulating covering element partially and surroundingly covers the second signal transmission element, and the second external grounding element includes a second front covering portion for partially and surroundingly covering the second insulating covering element, a second rear covering portion for partially and surroundingly covering the second grounding layer of the second signal transmission cable, and a second middle connecting portion connected between the second front covering portion and the second rear covering portion;
wherein a second side portion of the first signal transmission element and a second side portion of the second signal transmission element are pluggably matched with each other;
wherein the first insulating covering element and the second insulating covering element are separate from each other; and
wherein a first quick-release matching portion of the first front covering portion of the first external grounding element and a second quick-release matching portion of the second front covering portion of the second external grounding element are pluggably matched with each other.

4. The quick-detachable antenna signal transmission module according to claim 3,
wherein the first signal transmission cable includes a first inner insulating layer for covering the first conductive layer and a first outer insulating layer for covering the first grounding layer, and the first inner insulating layer is disposed between the first conductive layer and the first grounding layer so as to insulate the first conductive layer and the first grounding layer from each other;
wherein the second signal transmission cable includes a second inner insulating layer for covering the second conductive layer and a second outer insulating layer for covering the second grounding layer, and the second inner insulating layer is disposed between the second conductive layer and the second grounding layer so as to insulate the second conductive layer and the second grounding layer from each other;
wherein a portion of the first conductive layer of the first signal transmission cable is inserted into the first side portion of the first signal transmission element, and a portion of the second conductive layer of the second signal transmission cable is inserted into the first side portion of the second signal transmission element;
wherein the first signal transmission cable and the second signal transmission cable are electrically connected between a circuit substrate and an antenna structure, the first signal transmission cable is electrically connected to one of the circuit substrate and the antenna structure, and the second signal transmission cable is electrically connected to another one of the circuit substrate and the antenna structure;
wherein a portion of the first external grounding element and a portion of the first signal transmission cable are enclosed by a first quick-release structure matching casing, a portion of the second external grounding element and a portion of the second signal transmission cable are enclosed by a second quick-release structure matching casing, and the first quick-release structure matching casing and the second quick-release structure matching casing are detachably matched with each other;
wherein, when the first quick-release structure matching casing and the second quick-release structure matching casing are separated from each other, the second side portion of the first signal transmission element and the second side portion of the second signal transmission element are separated from each other, and the first quick-release matching portion of the first front covering portion of the first external grounding element and the second quick-release matching portion of the second front covering portion of the second external grounding element are separated from each other;
wherein, when the first quick-release structure matching casing and the second quick-release structure matching casing are matched with each other, the second side portion of the first signal transmission element is enclosed by the second side portion of the second signal transmission element, and the first quick-release matching portion of the first front covering portion of the first external grounding element is enclosed by the second quick-release matching portion of the second front covering portion of the second external grounding element;
wherein, when the first quick-release structure matching casing and the second quick-release structure matching casing are matched with each other, the second side portion of the first signal transmission element and the second side portion of the second signal transmission element are tightly matched with each other, and the first quick-release matching portion of the first front covering portion of the first external grounding element and the second quick-release matching portion of the second front covering portion of the second external grounding element are tightly matched with each other;
wherein the first signal transmission element has a first accommodation portion for covering a portion of the first conductive layer of the first signal transmission cable, and the second signal transmission element has a second accommodation portion for covering a portion of the second conductive layer of the second signal transmission cable;
wherein the first signal transmission element has a first embedded extension section and a first exposed protruding section connected to the first embedded extension section, and the first insulating covering element is configured to cover the first embedded extension section and abut against the first exposed protruding section, thereby limiting a position of the first signal transmission element relative to the first insulating covering element;
wherein the second signal transmission element has a second embedded extension section and a second exposed protruding section connected to the second embedded extension section, and the second insulating covering element is configured to cover the second embedded extension section and abut against the second exposed protruding section, thereby limiting a position of the second signal transmission element relative to the second insulating covering element;
wherein the first front covering portion of the first external grounding element has a first front slit for partially exposing the first insulating covering element, and the first rear covering portion of the first external grounding element has a first rear slit for partially exposing the first grounding layer of the first signal transmission cable; and
wherein the second front covering portion of the second external grounding element has a second front slit for partially exposing the second insulating covering element, and the second rear covering portion of the second external grounding element has a second rear slit for partially exposing the second grounding layer of the second signal transmission cable.

5. A quick-detachable antenna signal transmission module, comprising:
a first antenna signal transmission structure including a first quick-release structure matching casing and a first quick-release signal transmission assembly partially enclosed by the first quick-release structure matching casing; and
a second antenna signal transmission structure including a second quick-release structure matching casing and a second quick-release signal transmission assembly partially enclosed by the second quick-release structure matching casing;
wherein the second quick-release structure matching casing of the second antenna signal transmission structure is configured to be detachably connected to the first quick-release structure matching casing of the first antenna signal transmission structure; and
wherein the second quick-release signal transmission assembly of the second antenna signal transmission structure is configured to be detachably connected to the first quick-release signal transmission assembly of the first antenna signal transmission structure.

6. The quick-detachable antenna signal transmission module according to claim 5,
wherein the first quick-release structure matching casing includes a first structure body and a plurality of first pluggable buckle matching portions surroundingly connected to the first structure body;
wherein the second quick-release structure matching casing includes a second structure body and a plurality of second pluggable buckle matching portions surroundingly connected to the second structure body;
wherein, when the second quick-release structure matching casing of the second antenna signal transmission structure is configured to be detachably connected to the first quick-release structure matching casing of the first antenna signal transmission structure, the plurality of second pluggable buckle matching portions of the second quick-release structure matching casing are configured to be pluggably connected to the plurality of first pluggable buckle matching portions of the first quick-release structure matching casing respectively;
wherein each of the plurality of first pluggable buckle matching portions of the first quick-release structure matching casing includes a first buckle groove and a first buckle protrusion connected to the first buckle groove;
wherein each of the plurality of second pluggable buckle matching portions of the second quick-release structure matching casing includes a second buckle groove and a second buckle protrusion connected to the second buckle groove;
wherein, when the plurality of second pluggable buckle matching portions of the second quick-release structure matching casing are configured to be pluggably connected to the plurality of first pluggable buckle matching portions of the first quick-release structure matching casing respectively, the plurality of second buckle grooves of the plurality of second pluggable buckle matching portions of the second quick-release structure matching casing are configured to pluggably accommodate the plurality of first buckle protrusions of the plurality of first pluggable buckle matching portions of the first quick-release structure matching casing respectively, and the plurality of second buckle protrusions of the plurality of second pluggable buckle matching portions of the second quick-release structure matching casing are configured to be pluggably accommodated in the plurality of first buckle grooves of the plurality of first pluggable buckle matching portions of the first quick-release structure matching casing respectively;
wherein the first quick-release structure matching casing includes at least one first magnetic member, and the second quick-release structure matching casing includes at least one second magnetic member;
wherein, when the first antenna signal transmission structure and the second antenna signal transmission structure are matched with each other, the at least one first magnetic member disposed on the first quick-release structure matching casing and the at least one second magnetic member disposed on the second quick-release structure matching casing are magnetically attracted to each other;
wherein the first structure body of the first quick-release structure matching casing has a fixed position-limiting portion and a plurality of resilient position-limiting portions separate from the fixed position-limiting portion;
wherein, when the first quick-release structure matching casing of the first antenna signal transmission structure is configured to be fixed on an electronic product housing, the first structure body of the first quick-release structure matching casing passes through the electronic product housing to restrict the electronic product housing between the fixed position-limiting portion and each of the plurality of resilient position-limiting portions;
wherein the first antenna signal transmission structure further includes a detachable grounding cover, the detachable grounding cover is detachably disposed on the first quick-release structure matching casing and electrically connected to the first quick-release signal transmission assembly;
wherein the detachable grounding cover includes a grounding shell portion detachably disposed on the first quick-release structure matching casing and a grounding guide portion connected to the grounding shell portion and electrically contacting the first quick-release signal transmission assembly;
wherein the second antenna signal transmission structure further includes an external antenna assembly pivotally connected to the second quick-release structure matching casing and electrically connected to the second quick-release signal transmission assembly;
wherein the external antenna assembly includes an antenna shell portion pivotally connected to the second quick-release structure matching casing and at least one antenna structure portion disposed in the antenna shell portion and electrically connected to the second quick-release signal transmission assembly;
wherein the first quick-release structure matching casing of the first antenna signal transmission structure is detachably connected to another first quick-release structure matching casing of another first antenna signal transmission structure;
wherein the second quick-release structure matching casing of the second antenna signal transmission structure is detachably connected to another second quick-release structure matching casing of another second antenna signal transmission structure;
wherein the first antenna signal transmission structure includes another first quick-release signal transmission assembly partially enclosed by the first quick-release structure matching casing, and the two first quick-release signal transmission assemblies are separate from each other; and
wherein the second antenna signal transmission structure includes another second quick-release signal transmission assembly partially enclosed by the second quick-release structure matching casing, and the two second quick-release signal transmission assemblies are separate from each other.

7. The quick-detachable antenna signal transmission module according to claim 5,
wherein the first quick-release signal transmission assembly of the first antenna signal transmission structure further includes: a first signal transmission cable, a first signal transmission element, a first insulating covering element and a first external grounding element, the first signal transmission cable includes a first conductive layer and a first grounding layer separate from each other, a first side portion of the first signal transmission element electrically contacts the first conductive layer of the first signal transmission cable, the first insulating covering element partially and surroundingly covers the first signal transmission element, and the first external grounding element includes a first front covering portion for partially and surroundingly covering the first insulating covering element, a first rear covering portion for partially and surroundingly covering the first grounding layer of the first signal transmission cable, and a first middle connecting portion connected between the first front covering portion and the first rear covering portion;
wherein the second quick-release signal transmission assembly of the second antenna signal transmission structure further includes: a second signal transmission cable, a second signal transmission element, a second insulating covering element and a second external grounding element, the second signal transmission cable includes a second conductive layer and a second grounding layer separate from each other, a first side portion of the second signal transmission element electrically contacts the second conductive layer of the second signal transmission cable, the second insulating covering element partially and surroundingly covers the second signal transmission element, and the second external grounding element includes a second front covering portion for partially and surroundingly covering the second insulating covering element, a second rear covering portion for partially and surroundingly covering the second grounding layer of the second signal transmission cable, and a second middle connecting portion connected between the second front covering portion and the second rear covering portion;
wherein a second side portion of the first signal transmission element and a second side portion of the second signal transmission element are pluggably matched with each other;
wherein the first insulating covering element and the second insulating covering element are separate from each other; and
wherein a first quick-release matching portion of the first front covering portion of the first external grounding element and a second quick-release matching portion of the second front covering portion of the second external grounding element are pluggably matched with each other.

8. A method for manufacturing a quick-detachable antenna signal transmission module, comprising:
making a first antenna signal transmission structure, wherein the first antenna signal transmission structure includes a first quick-release structure matching casing and a first quick-release signal transmission assembly partially enclosed by the first quick-release structure matching casing;
making a second antenna signal transmission structure, wherein the second antenna signal transmission structure includes a second quick-release structure matching casing and a second quick-release signal transmission assembly partially enclosed by the second quick-release structure matching casing; and
detachably matching the first antenna signal transmission structure and the second antenna signal transmission structure with each other;
wherein, when the first quick-release structure matching casing of the first antenna signal transmission structure is configured to be fixed on an electronic product housing, the second quick-release structure matching casing of the second antenna signal transmission structure is configured to be detachably connected to the first quick-release structure matching casing of the first antenna signal transmission structure, and the second quick-release signal transmission assembly of the second antenna signal transmission structure is configured to be detachably connected to the first quick-release signal transmission assembly of the first antenna signal transmission structure.

9. The method according to claim 8,
wherein the first quick-release signal transmission assembly of the first antenna signal transmission structure includes a first signal transmission cable, a first signal transmission element, a first insulating covering element, and a first external grounding element, the first signal transmission cable includes a first conductive layer and a first grounding layer separate from each other, the first external grounding element includes a first front covering portion for partially covering the first insulating covering element, a first rear covering portion for partially covering the first grounding layer of the first signal transmission cable, and a first middle connecting portion connected between the first front covering portion and the first rear covering portion;
wherein the second quick-release signal transmission assembly of the second antenna signal transmission structure includes a second signal transmission cable, a second signal transmission element, a second insulating covering element, and a second external grounding element, the second signal transmission cable includes a second conductive layer and a second grounding layer separate from each other, the second external grounding element includes a second front covering portion for partially covering the second insulating covering element, a second rear covering portion for partially covering the second grounding layer of the second signal transmission cable, and a second middle connecting portion connected between the second front covering portion and the second rear covering portion;
wherein the step of making the first antenna signal transmission structure further includes: forming the first front covering portion by bending; placing the first insulating covering element into the first front covering portion so as to cover the first insulating covering element through the first front covering portion; placing the first signal transmission element into the first insulating covering element so as to cover the first signal transmission element through the first insulating covering element; forming the first rear covering portion by bending to partially cover the first grounding layer of the first signal transmission cable; and forming the first quick-release structure matching casing to cover a portion of the first external grounding element and a portion of the first signal transmission cable;
wherein the step of making the second antenna signal transmission structure further includes: forming the second front covering portion by bending; placing the second insulating covering element into the second front covering portion so as to cover the second insulating covering element through the second front covering portion; placing the second signal transmission element into the second insulating covering element so as to cover the second signal transmission element through the second insulating covering element; forming the second rear covering portion by bending to partially cover the second grounding layer of the second signal transmission cable; and forming the second quick-release structure matching casing to cover a portion of the second external grounding element and a portion of the second signal transmission cable;
wherein the first antenna signal transmission structure and the second antenna signal transmission structure are in electrical contact with each other by pluggably matching the first quick-release structure matching casing and the second quick-release structure matching casing with each other; and
wherein, when the first antenna signal transmission structure and the second antenna signal transmission structure are matched with each other, a second side portion of the first signal transmission element and a second side portion of the second signal transmission element are pluggably matched with each other, the first insulating covering element and the second insulating covering element are separated from each other, and a first quick-release matching portion of the first front covering portion of the first external grounding element and a second quick-release matching portion of the second front covering portion of the second external grounding element are pluggably matched with each other.

10. The method according to claim 8,
wherein the first quick-release structure matching casing includes a first structure body and a plurality of first pluggable buckle matching portions surroundingly connected to the first structure body;
wherein the second quick-release structure matching casing includes a second structure body and a plurality of second pluggable buckle matching portions surroundingly connected to the second structure body;
wherein, when the second quick-release structure matching casing of the second antenna signal transmission structure is configured to be detachably connected to the first quick-release structure matching casing of the first antenna signal transmission structure, the plurality of second pluggable buckle matching portions of the second quick-release structure matching casing are configured to be pluggably connected to the plurality of first pluggable buckle matching portions of the first quick-release structure matching casing respectively;
wherein each of the plurality of first pluggable buckle matching portions of the first quick-release structure matching casing includes a first buckle groove and a first buckle protrusion connected to the first buckle groove;
wherein each of the plurality of second pluggable buckle matching portions of the second quick-release structure matching casing includes a second buckle groove and a second buckle protrusion connected to the second buckle groove;
wherein, when the plurality of second pluggable buckle matching portions of the second quick-release structure matching casing are configured to be pluggably connected to the plurality of first pluggable buckle matching portions of the first quick-release structure matching casing respectively, the plurality of second buckle grooves of the plurality of second pluggable buckle matching portions of the second quick-release structure matching casing are configured to pluggably accommodate the plurality of first buckle protrusions of the plurality of first pluggable buckle matching portions of the first quick-release structure matching casing respectively, and the plurality of second buckle protrusions of the plurality of second pluggable buckle matching portions of the second quick-release structure matching casing are configured to be pluggably accommodated in the plurality of first buckle grooves of the plurality of first pluggable buckle matching portions of the first quick-release structure matching casing respectively;
wherein the first quick-release structure matching casing includes at least one first magnetic member, and the second quick-release structure matching casing includes at least one second magnetic member;
wherein, when the first antenna signal transmission structure and the second antenna signal transmission structure are matched with each other, the at least one first magnetic member disposed on the first quick-release structure matching casing and the at least one second magnetic member disposed on the second quick-release structure matching casing are magnetically attracted to each other;
wherein the first structure body of the first quick-release structure matching casing has a fixed position-limiting portion and a plurality of resilient position-limiting portions separate from the fixed position-limiting portion;
wherein, when the first quick-release structure matching casing of the first antenna signal transmission structure is configured to be fixed on the electronic product housing, the first structure body of the first quick-release structure matching casing passes through the electronic product housing to restrict the electronic product housing between the fixed position-limiting portion and each of the plurality of resilient position-limiting portions;
wherein the first antenna signal transmission structure further includes a detachable grounding cover, the detachable grounding cover is detachably disposed on the first quick-release structure matching casing and electrically connected to the first quick-release signal transmission assembly;
wherein the detachable grounding cover includes a grounding shell portion detachably disposed on the first quick-release structure matching casing and a grounding guide portion connected to the grounding shell portion and electrically contacting the first quick-release signal transmission assembly;
wherein the second antenna signal transmission structure further includes an external antenna assembly pivotally connected to the second quick-release structure matching casing and electrically connected to the second quick-release signal transmission assembly;
wherein the external antenna assembly includes an antenna shell portion pivotally connected to the second quick-release structure matching casing and at least one antenna structure portion disposed in the antenna shell portion and electrically connected to the second quick-release signal transmission assembly;
wherein the first quick-release structure matching casing of the first antenna signal transmission structure is detachably connected to another first quick-release structure matching casing of another first antenna signal transmission structure;
wherein the second quick-release structure matching casing of the second antenna signal transmission structure is detachably connected to another second quick-release structure matching casing of another second antenna signal transmission structure;
wherein the first antenna signal transmission structure includes another first quick-release signal transmission assembly partially enclosed by the first quick-release structure matching casing, and the two first quick-release signal transmission assemblies are separate from each other; and
wherein the second antenna signal transmission structure includes another second quick-release signal transmission assembly partially enclosed by the second quick-release structure matching casing, and the two second quick-release signal transmission assemblies are separate from each other.
